(19) United States
(12) Patent Application Publication
(10) Pub. No.: US 2016/0125010 A1
(43) Pub. Date: May 5, 2016

(54) METHOD OF TRACKING THE DISTRIBUTION OF INFORMATION

(71) Applicant: BEST WORLDWIDE LIMITED, Kent (GB)

(72) Inventor: MICHAEL JEREMY KEW, Kent (GB)

(21) Appl. No.: 14/896,037

(22) PCT Filed: May 23, 2014
(86) PCT No.: PCT/GB2014/051594

§ 371 Date: Dec. 4, 2015

(30) Foreign Application Priority Data
Jun. 5, 2013 (GB) 1310035.9

(51) Int. Cl. G06F 17/30; G06Q 30/02

(52) U.S. Cl. CPC G06F 17/30339; G06F 17/30882; G06Q 30/0214

(57) ABSTRACT

A method of tracking the distribution of information, the method comprising: providing to a first user a first token comprising a first unique identifier and a first address; storing in a first database table a link between the first user and the first token; receiving at the first address a request from a second user, the request being made using the first token which has been received by the second user from the first user; storing in a second database table a link between the first token and the second user; providing to the second user a second token comprising a second unique identifier and a second address in response to the request; and storing in a third database table a link between the second token and the second user.

### RELATED APPLICATIONS

This application claims benefit of and priority to GB patent application, with application number GB 1310035.9 filed 5 Jun. 2013, and this application is incorporated herein by this reference in its entirety.

### INTRODUCTION

The present invention relates to a method of tracking the distribution of information, in particular from one user to another and another. The present invention also relates to a method of receiving information, passing information to another user and tracking the movement of this information. The present invention also provides an apparatus and a computer program to track the distribution of information.

### BACKGROUND OF THE INVENTION

Technical systems for tracking and monitoring the distribution of information in pre-existing networks are known, see for example US 2009/0157497 and US 2011/0218846. Users of these networks are already known to each other and these relationships are known to the system such that information can be passed between them using the system. For example, a first user can pass information to further users within his or her own personal network, and a second user, within the first user's personal network, can then pass information to users within his or her personal network. In this way information can be passed from user to user and tracked, but is limited to movement of information in pre-existing networks.

The passing of information between customers, e.g. word of mouth recommendation, is well known to improve sales and is an extremely effective way of advertising. Although referrals between customers are well known, determining how a referral has reached a user who buys a product or claims an offer etc. is difficult to determine. The present invention is not related to generating referrals or using word of mouth for the purposes of advertising. The present invention aims to track how information is passed. This is a difficult technical problem because it is not clear what path information may have taken from one user to another. A number of attempts have previously been made, as are discussed below.

US 2011/0218846 tracks referrals between users. US 2001/0218846 stores member information, determines relationships between the members using the member information, creates a data structure representing the member relationships and determines other members in the data structure that contribute to a member making a purchase.

US 2011/0218846 discloses that user referrals can be tracked by the user accessing links on other user's pages within a pre-existing network and the system can determine which users may have contributed to the purchase based on the data structure of the connected members. In an example of US 2011/0218846, a member creates a code, which another member uses when purchasing an item such that the code can be tracked back to the user who created the code.

US 2009/0157497 discloses a method for electronically communicating comments from one participant to another within a network. In US 2009/0157497, participants invite other participants to join their personal network, for an invitee to accept the invitation, they must be registered with the network. A participant sends a comment to another participant within their personal network in relation to a particular product or service. The participant can then pass the comment on to another participant in their personal network. US 2009/0157497 tracks the comment using a server to detect a resource identifier, however, no further information is given on how or how far the comment is tracked.

None of the above prior art fully address the problem of tracking the movement of information through a number of users.

### SUMMARY OF THE INVENTION

It is an aim of the present invention to provide improved methods, an apparatus and a computer program for tracking the distribution or dissemination of information via multiple media and multiple users. A more specific aim of the present invention is to provide methods, an apparatus and a computer program for tracking the distribution or dissemination of information via multiple media and multiple users, independently of any pre-existing network of relationships.

The present invention provides a method of tracking the distribution of information, the method comprising: providing to a first user a first token comprising a first unique identifier and a first address; storing in a first database table a link between the first user and the first token; receiving at the first address a request from a second user, the request being made using the first token which has been received by the second user from the first user; storing in a second database table a link between the first token and the second user; providing to the second user a second token comprising a second unique identifier and a second address in response to the request; and storing in a third database table a link between the second token and the second user.

When a token is used by a second user to request their own token, information linking the second user to the first user to whom the token was issued, is stored in at least one database table. The information stored in the database table can then be used to determine how a given user received a token. This provides the technical advantage of allowing the movement of information to be tracked. This may be beneficial for users or a source of information to determine the most efficient way to make information available to as many users as possible in the future.

Therefore, the present invention tracks the transfer of information from one user to another. The present invention allows tokens to be passed from one user to another user without a pre-existing relationship between the users, and is still capable of monitoring the movement of information and the possible formation of new relationships. The present invention is thus able to track the actual route of dissemination of a piece of information rather than assuming that information follows a path in a pre-existing network. The present invention provides the benefit of not having to use a personal network in which user relationships are already formed. The present invention allows information to be passed to a variety of different users, including those not already connected in some way to the user.

In the present invention, details are stored in at least one database in relation to tokens and identifiers. The stored details represent links between each user and the information which is being passed on. This allows the technical mapping and tracking of the way in which information is distributed and allows the monitoring of information distribution.

In an embodiment, the present invention further comprises receiving at the second address a request from a third user, the request from the third user being made using the second token which has been received by the third user from the second user; storing in a fourth database table a link between the second token and the third user; providing to the third user a third token comprising a third unique identifier and a third address in response to the request from the third user; and storing in a fifth database table a link between the third token and the third user.

In such an embodiment, the present invention can be extended to multiple users. There is no theoretical limit on the number of users the tokens can be passed to in a chain. This provides the advantage that information can pass to a large number of people in any one chain and the distribution of this information can still be monitored and tracked. It should be noted that each of the first, second and third users as given can be any of the users in a chain. The first user can receive a first token from a source or can receive a token from a user at any position in a chain of users.

Similarly, the numbering of the addresses, unique identifiers, database tables and tokens are to indicate the correlation to a specific user, as described. Given that the user could in fact be any user in a chain, each of the addresses, unique identifiers, database tables and tokens could also be at any point in the chain, the numbering just indicates which user they are each associated with.

In an embodiment, the present invention further comprises receiving at the first address a request from a fourth user, the request from the fourth user being made using the first token which has been received by the fourth user from the first user; storing in a sixth database table a link between the first token and the fourth user; providing to the fourth user a fourth token comprising a fourth unique identifier and a fourth address in response to the request from the fourth user; and storing in a seventh database table a link between the fourth token and the fourth user.

In such an embodiment, the fourth user also receives a token from the first user, in the same way that the second user receives a first token from the first user. In this way, information can be passed to multiple users from an individual user. There is no theoretical limit on the number of users the tokens can be passed to by one user. Therefore, any number of users can receive a first token from the first user, and/or a second token from the second user, and/or a third token from the third user and so on. Furthermore, any number of users can then pass this token on to at least one other user which shows how information can quickly be distributed to a large number of users. This has an advantage that information can be disseminated efficiently and quickly, whilst also tracking the movement of information. A network to represent how the information is passed between users can be represented as a tree, with an arbitrary number of branches at each node. Each node represents a user and each branch the link between users by which the information was distributed.

In an embodiment, the present invention further comprises storing a link between a token and a data item in an eighth database table. In such an embodiment, the data item can also be supplied to the second (or nth) user in response to the request therefrom. The link between the data item and a token can be stored in different ways. A link can be stored between each token and a data item, such that a direct link between the token and data item is stored each time, e.g. a link is stored between the data item and a first token, and a link is stored between the data item and a second token, etc. This has the advantage that the token can be directly and easily linked to a data item. However, it also requires the storage of more information because a link between each token and the data item must be stored. Alternatively, the link between a token and data item can be stored by storing a link between the data item and the first token, and then storing a link between each token back to the data item. This has an advantage that it uses the system already in place to track the information linking the tokens.

In an embodiment of the present invention, each token further comprises a link to a data item. Therefore, each token includes its own link to a data item. Each token being linked to a data item means that information can be easily represented and passed from user to user without having to send all the information relating to the data item. This has an advantage that each token can be directly and easily linked to a data item.

By storing a link between a token and a data item in a database table and/or by providing a link to a data item in each token, information can be passed from user to user in the form of a token without having to pass all the information included in a data item from one user to the next. Therefore, only the representation of the data item, i.e. the token, needs to be passed on. This provides a technical advantage that information relating to the data item can be made available to users without having to send large amounts of information between users which may slow down certain systems and/or reduce the system's efficiency. The second user's request can be combined with or inferred from a use of the link to access the data item.

In an embodiment of the present invention, each token generated in response to a request using a previous token, is linked to the same data item as the previous token. Therefore, each token can link to the same data item either by a link in the token, direct link to the token or by the tokens linking back to a data item in a chain. This means that when a token is passed from one user to another each token is linked back to the same data item. This means that all the tokens which have been passed from user to user can link back to the same data item i.e. the same information. A token representing certain information can be passed to a variety of users without having to provide all the information or details of the data item each time this is passed to the next user.

In an embodiment of the present invention, when a user uses a further token that is linked to a data item to make a request, and that user is already linked to a token that is linked to the same data item, no further link between the user and the further token is made. This has an advantage of preventing loops from being created in the network. If loops were present in the network it might become more difficult to determine how a token was first received by a user and may make the system more complicated such that it is less efficient. By avoiding loops in the system it ensures that the tree network represents the route by which a user received a token that they chose to use.

In an embodiment of the present invention, the method can further comprise a step of determining how a user received a token by assembling a chain of users, using the information stored in the database tables. Therefore, the distribution of information can be easily determined, i.e. the movement of information can be tracked, and the relationship between different users can also be tracked by looking at how the information has passed from one user to another. This is beneficial because it shows an easy way of providing links between users and certain information. Given that the information can be passed to such a variety of users by such a variety of means, the ability to track how the information has passed from user to user is extremely useful. The present invention enables transient or specific networks to be identified. A user may pass information of one type to a subset of that user's connections and information of another type to a different subset. The structures within a user's network are revealed. The tracking of the movement of information can be used and applied in a number of different ways.

In such an embodiment, the information including all the links in a chain of users and/or a tree may be stored all together. The information can be duplicated from other database tables to provide all the information related to a single chain or data item in one database table. The information can be duplicated and grouped in a specific way. For example, it may be beneficial to provide database tables with all the movement of information in relation to a source or a user.

In an embodiment of the present invention, the data item is a representation of an offer. An offer can be an offer to supply real or virtual goods or services of value to a user on favourable or discounted terms. If the data item represents an offer, it can provide an incentive for the user to review the token and then use it to request a new token to pass on to other users. In such an embodiment, a user who exercises the offer can be regarded as having received a value, e.g. in the form of a discount, cash back or extra goods or services.

In an embodiment of the present invention, a record is provided of all the users in a chain of users, through which the user who exercises the offer, has received the token. Therefore, the chain of users can be easily determined. The movement of information can be easily tracked. Further analysis of how information is passed from user to user is likely to be easier if a record can be provided showing the movement of information.

In an embodiment of the present invention, a user who exercises an offer associated with the token receives a reward in accordance with the offer. This provides a clear benefit to the user exercising the offer.

In an embodiment of the present invention, a reward is received by all users in a chain of users through which the user who exercises the offer received the token. Therefore, all the users in such a chain of users benefit when a user exercises an offer.

In an embodiment of the present invention, the value of the reward received by users in the chain reduces from user to user up the chain from the user exercising the offer to the user who receives a token from a source. Multiple users in a chain of users of users can exercise the offer. The reward is determined each time the offer is exercised, from the user who exercised the offer back to the first user who first received the token from the source. The reward may reduce in value from user to user by a predetermined proportion.

In an embodiment of the present invention, the reward reduces from user to user by a predetermined proportion, optionally wherein this predetermined proportion is 1/n, n being an integer greater than 1. Using a predetermined proportion, i.e. 1/n, means that the amount each user in a chain receives can be calculated dependent on the value of n, and how far along the chain any user is from the user who exercised the offer. Also, the sum of the rewards to the users in the chain is limited, no matter how long the chain. For example, if n is 2, the reward is reduced by half from user to user. Using n=2 has the advantage that all the predetermined proportions sum to 1 if the theoretical number of users approaches infinity.

In an embodiment of the present invention, the identifier can be created when a request is made by a user or the identifier can be created before a request from a user. This means there is flexibility in how the user identification is created. The identifiers can be created before a user request is received such that the request is not necessary for the identifiers to be created. In this case, the system may generate a number of identifiers which are then assigned to a user in response to a request. The identifiers can be randomly assigned, or they can be allocated in a specific way. Alternatively, identifiers might only be made in response to a request. The generation of the identifiers may be random.

In an embodiment of the present invention, at least two of the addresses can be the same. If the addresses are different, this means that the request for a token can be received at any number of addresses in order for the user to use the token. Alternatively, the addresses can be the same, for example a shop or a internet site where the tokens can be received. The tokens can be received at the address in an exchange with the user. In an embodiment of the invention, an address and a unique identifier are combined in a URL.

In an embodiment of the present invention, at least two of the database tables can be the same. The first database table can be the same as the second database table and/or the second database table can be the same as the third database table, etc. Therefore, information can be stored in a number of database tables or in the same database table. The storage of this information can be determined depending on what is most convenient for the type and amount of information that is being stored. If the information is being stored in the same database table, it is likely that each new information link is stored on a new row within one database table. In this way, one database table can contain all the links between users starting from a first user who has requested the initial token from a source, to all the users who have subsequently received a token linked to the same data item. There can then be multiple database tables indicating how the information has passed amongst the multiple users in a tree-like shape. A given table can be divided between multiple servers and/or multiple replicas if a table can be stored in multiple servers.

The present invention also provides a method of distributing information, the method comprising: receiving at a first address a first token comprising a first unique identifier and a first address; sending a request including the first unique identifier to the first address; receiving a second token comprising a second unique identifier and a second address; and making the second token available to another person.

The present invention also provides a method of distribution information the method comprising: providing a data item; generating a token linked to the data item and comprising a first unique identifier and a first address; wherein the token is usable in a method according to any of the embodiments of the present invention; making the token available to other persons.

The present invention also provides an apparatus for tracking the distribution of information, the apparatus configured to provide to a first user a first token comprising a first unique identifier and a first address; store in a first database table a link between the first user and the first token; receive at the first address a request from a second user, the request being made using the first token which has been received by the second user from the first user; store in a second database table a link between the first token and the second user; provide to the second user a second token comprising a second unique identifier and a second address in response to the request; and store in a third database table a link between the second token and the second user.

The present invention also provides a computer program for tracking the distribution of information, the computer program providing to a first user a first token comprising a first unique identifier and a first address; storing in a first database table a link between the first user and the first token; receiving at the first address a request from a second user, the request being made using the first token which has been received by the second user from the first user; store in a second database table a link between the first token and the second user; providing to the second user a second token comprising a second unique identifier and a second address in response to the request; and storing in a third database table a link between the second token and the second user.

### LIST OF FIGURES

The present invention is described below with reference to exemplary embodiments and the accompanying drawings in which:

FIG. 1 shows a source creating an account in an embodiment of the present invention.

FIG. 2 shows a data model of a source creating an account in an embodiment of the present invention.

FIG. 3 shows a source making a data item available in an embodiment of the present invention.

FIG. 4 shows a data model of the source making a data item available in an embodiment of the present invention.

FIG. 5 shows a user creating an account in an embodiment of the present invention.

FIG. 6 shows a data model of a user creating an account in an embodiment of the present invention.

FIG. 7 shows a user receiving a token from a source in an embodiment of the present invention.

FIG. 8 shows a data model of a user receiving a token from a source in an embodiment of the present invention.

FIG. 9 shows another user receiving a token and requesting their own token from the previous user in an embodiment of the present invention.

FIG. 10 shows a data model of another user receiving a token and requesting their own token from the previous user in an embodiment of the present invention

FIG. 11 shows a transaction when a user uses their token to exercise an offer in an embodiment of the present invention.

FIG. 12 shows a data model of a transaction when a user uses their token to exercise an offer in an embodiment of the present invention.

FIG. 13 shows the network system of an embodiment of the present invention, indicating the tree like structure created as tokens are passed from one user to another.

### DETAILED DESCRIPTION OF THE INVENTION

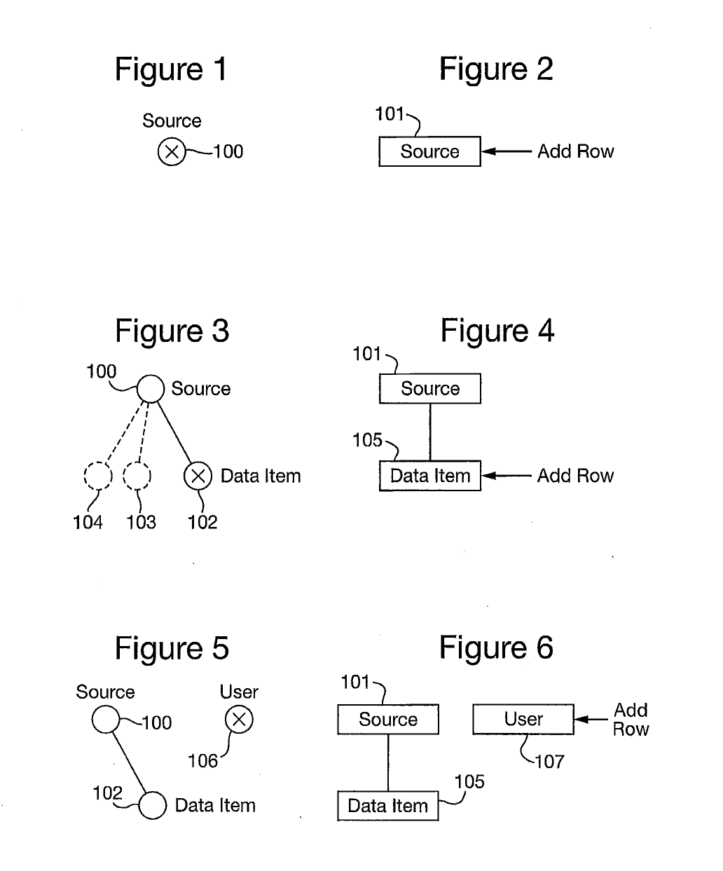

In the first step of an embodiment of the present invention, a source creates an account 100 as shown in the logical model of FIG. 1. The source account 100 is created in this step as indicated by the “X”. The “X” in the Figures is used to indicate the data item added in the step depicted in that Figure.

The source is a person or business who provides a data item. The source creates an account 100 on an internet site which allows them to make the data item available to others. The source is the first person to make a data item available. The source chooses the details of a data item to be made available and how it is made available. The source can determine the terms and conditions and information given in the data item. The source may provide at least one data item on the system using their account 100.

When the source creates an account 100, a row is added in a database table 101 in which information relating to the source account 100 is saved, as can be seen in FIG. 2. FIG. 2 shows the data model of a source creating an account 100. The source will have to provide certain information to register, i.e. to create an account. The information can include, but is not limited to, a username and/or email address and password. Other information which may be required can include first name, surname, age, gender, bank details, etc.

The source can create their account 100 on the internet site at any time. The source can create their account 100 when they first wish to make a data item available. Alternatively, the source can create their account 100 at any time before they are ready to make a data item available. The source can also create their account using a downloadable app. The source can download the app to a device and create an account. The source can the use the app to make a data item available. An app could be used in any instance instead of an internet site.

In the next step of the present embodiment, the source creates a data item 102 to be made available, as seen in FIG. 3. The source can make as many data items available as they like, which can be seen from the multiple dashed-line nodes 103, 104 connected to the source in FIG. 3. The source will provide information in relation to each data item 102. Tokens are available which relate to each data item 102 in some way. As previously described, the token can link to a data item 102, or the first token received can link to the data item 102 and then each token links to each other in a chain. In either case, any direct link with the data item 102 is stored in a database table. In an embodiment, the token itself comprises a link to the data item 102. As shown in FIG. 4, when the data item 102 is made available, a row is added to a data item database table 105 which includes the details of the data item 102. The link between the source and the data item 102 is also stored.

Therefore, the token can comprise information relating to the data item. Therefore, the token can comprise a link to a data item and/or the token can comprise some of the information contained in the data item, or it can include all of the information contained in the data item.

The data item 102 may be made available by posting it on-line, or publishing it on an internet site. When a data item 102 is made available, this means that any user may be able to request a token relating to the data item 102 (whether or not they are already registered on the internet site). The data item 102 may be made available by the source actively, i.e. the source sends tokens relating to the data item 102 through a variety of different media directly to at least one user. The data item 102 may be made available by the source passively, in which case, tokens relating to the data item 102 are made available. In this case a user may search for the data item 102 or come across the data item 102 and request a token from the source.

A user is a term used to describe a person. A person does not have to be a member of any network for a token to be made available to them.

The data item 102 can be made available in multiple ways including email, Facebook™ radio, Twitter™, television, adverts in magazines, adverts on internet sites, using QR codes, chirping, SMS, MMS, word of mouth, etc.

A data item 102 has an ID, terms (e.g. 6% of sale value) and a unique code. The code is to be used to identify the data item 102 when it is first being made available eg when an offer is first being offered to the ‘market’. The unique code is a number expressed in base 62, 8 columns (although other coding systems can be used including using a different base number or different number of columns). This gives at least 218,340,105,584,896 values. Base 62 has the character set 0-9, A-Z and a-z. Further character sets can be used to alter the base used if the total number of offer codes generated needed to be increased. The unique code can be randomly generated to reduce fraud as users cannot predict the code to be used for any data item 102. Also, the symbol space provided can be used sparsely to enable error detection and correction.

In the next step of the embodiment, a user creates an account 106 as shown by the logical user object in FIG. 5. Similarly to when a source creates a new account 100, the user may have to provide certain information such as a username and/or email address, and a password. Other information which may be required can include first name, surname, age, gender, bank details, etc. As can be seen from FIG. 6, a new row is then added to a user database table 107. This row contains information in relation to this user.

A user can create an account 106 on the internet site at any time. The user creates an account 106 by registering on the internet site. The user can do this at a point in time in which they become aware of the available site. Alternatively, they may do this when they receive a token from another user or the source, or when they find a data item 102 which they wish to claim. The user may have an account 106 before the source creates an account 100 and/or before the source makes a data item 102 available. A user can create their account using a downloadable app rather than an internet site.

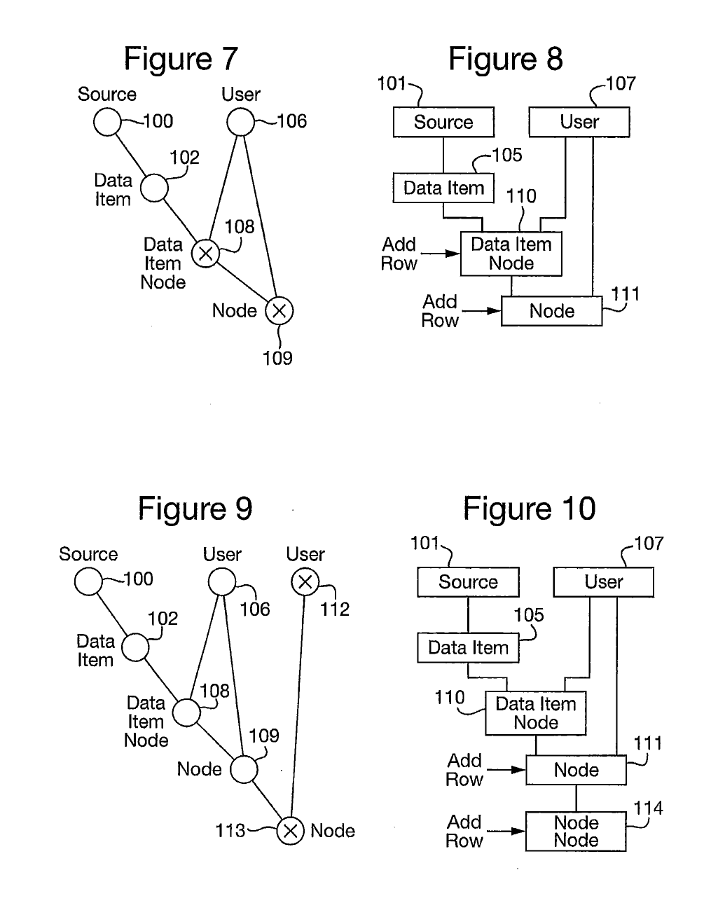

In the next step of the embodiment, the (first) user selects the data item 102, as shown in FIG. 7. As can be seen, the first user to select the data item 102 creates a data item node 108. A link is provided which directly links the user to the data item node 108. Additionally, a node 109 is created which represents a token which can then be used by the first user and/or passed on to other users. As shown in FIG. 8, when the data item node 108 is created, this adds an additional row to a data item node database table 110 which indicates the link between the data item 102 and the user who has selected it. A data item node 108 will be created for each different user who selects the data item 102 directly from a source. Each time, a node 109 is also created, which adds a row to a node database table 111. The node 109 indicates a link between the user and the data item node 108, as can be seen in FIG. 8. Therefore, a node 109 in the logical model in FIG. 7 is equivalent to the node database table 111 or a row in a database table in FIG. 8.

When the user has received a token, the user can choose to do nothing with the token. Alternatively, the user may use the token to request their own tokens, and/or the user can pass the token on to other users, and/or the user can access the data item linked to the token. Some steps of the method of distributing information may be automated, for example, by use of an app which is downloaded to a user's device, such that a user automatically uses a token when they receive a token relating to a data item 102 to which they are not already linked to i.e. the system automatically requests a token of their own. A user who receives a token may access the data item 102 without using the token to request their own token. Therefore, the user can receive the information from a source or a user without receiving their own token to pass on to another user. Therefore, the user does not have to use the token to request their own token in order to access the data item 102. In this case, when the user accesses the data item, a link can be formed between the user and the data item. If the user is logged into their account, they can be identified when they access the data item, and the token passed to the user can be identified by the unique identifier, such that the distribution of information can be tracked.

The information provided in each token means that the user can easily send a request to the appropriate address to use the token. The user can also be easily identified because the request includes the unique identifier. Therefore, it is possible to determine how a user has used the information given to them via the token. Information relating to the use of the token can be stored.

The step of providing to the first user a first token comprising a first unique identifier and a first address can be carried out by suitable means. Suitable means include email, Facebook™ (message or wall post), radio, Twitter™, television, adverts in magazines, adverts on internet sites, using QR codes, chirping, SMS, MMS, word of mouth, Near field Communication, etc. Information is stored linking the first user to the first token. The first user then makes this information available to as many users as they wish, by any suitable means, e.g. those specified above. The information can be made available actively or passively, as previously described. The information can also be passed on to users using a pre-existing social network, however, this is not necessary. The first user uses the token and then may choose to send their token specifically to people within their own social network. In particular, the first user may choose specific people with whom they are already connected who they think would have a particular interest in the information they are providing. The user may provide the information to people not within any of their social networks. This may be done in a way that provides the information to a large number of people, and/or is passing the information on, irrespective of whether or not it is likely that the further user(s) will be interested in the information and/or irrespective of the likelihood that the further user(s) will use it.

The unique identifier of each token is individual to each user. The identifier can alter as a token is passed from user to user. The unique identifier can be randomly generated each time a new token is generated. Alternatively, the unique identifier can be an adaptation of the unique identifier in a previous token (which is related to the same data item 102). The unique identifier would typically be base 62, 8 columns (although other coding systems can be used including using different base systems and/or column numbers). The unique identifier can be randomly generated to reduce fraud as users cannot predict the code to be used for any offer. Further character sets can be used to alter the base used if the total number of unique identifiers generated needed to be increased.

When a user wishes to use a token, i.e. when a user receives a token and requests their own, they may have to do so through an internet site. This means that a user who is already a member of the internet site will have to log onto the internet site. Site log on may at the necessary if the site recognises the user, e.g. using a cookie, other device identification, or non-site specific identification service. However, if a user is not already a member, they will have to register with the internet site. A token can be forwarded to people who are not yet users. People who are not users are not registered on the internet site i.e. do not yet have an account on the internet site. This means the users are not yet registered and can not log on to the internet site. If the user does have an account 106, they will be able to log on to the internet site using a username and/or email address and a password. The username and/or email address and the password combination will be specific for each user. The username and/or email address is a means to identify the user when logging on to the internet site. When a user logs into the internet site, they will then be able to claim the token from the source (or at a later stage, from a previous user). A downloadable app can be used instead of an internet site in the same way.

The passing on of information can be repeated. The first user in this instance is the first user who selects the data item 102 from the source. However, the first user can be any user who is connected to a node i.e. is connected to a token. The numbering of the users is used to help describe the various positions of users within any one chain to show how a node has passed from person to person. Also numbering the users can help to describe the different possible positions of users in a tree, in which the information can pass to multiple users to create multiple chains stemming from one individual data item 102 or source. The numbering of the users does not indicate the position of the user in a chain, it is merely a numbering system to help explain the present invention.

In FIG. 9 another user creates an account 112. Similarly to the previous user, this user will have to provide the relevant information to register on the internet site. This user is different from the first user. Information in relation to this user will be stored in the user database table. When the user selects the node 109 made available by the first user, a further node 113 is created. This node 113 is a “child” node, i.e. it comes from a “parent” node. Each child node cannot have more that one parent node. However, each parent node can have multiple child nodes. The link between the first node 109 and the second node 113 may be expressed either as a node-node record in a node-node database table 114. In other words the link is stored in a node-node database table 114. Alternatively, the link between the first 109 and second node 113 may be expressed as a foreign key in the node database table 111. This is shown in FIG. 10 in that a new row can be added in the existing node database table 111 with a foreign key. A foreign key is a piece of data in a database table which relates to data in another row of the database table and/or another row in a different database table.

A user who selects a node 109 has received the first token. The user can use the first token to request their own token and/or can access the data item 102 limited to the first token or can do nothing. The user requests their own token by using the information in the first token. The address is used to direct the user to where they can request their token. When this request is made, information providing a link between the user making the request and the previous token is stored. The user receives their own token and information linking the user to their own token is also stored.

When a token is passed to a user and they use the token to request their own token, which they then pass on to another user, and so on, this creates a chain of users. The chain starts with a source making a data item 102 available. Then a user requesting a token linked to the data item 102. Any number of users in a chain of users can be downstream of a user who requests a token from the source. Also, unless a token is received directly from the source, there will be at least one user upstream from a user who has received a token.

The user may pass the token on to other users whether or not they are already registered as members of an internet site. If a user receives a token and does not use it to request their own token, but does pass on the token, the user may become invisible to the system because information related to the user and the passing of the token is not stored. The user can access the data item 102 relating to the token and pass it on, or may simply pass the token on without accessing the data item 102. The user may choose not to use the token in any way either by using the token (i.e. requesting their own token), passing on the token and/or accessing the data item 102 related to the token. The user can pass the token to other users using any suitable means, including all the means in which the source may choose to first make the token available to users. When the first user passes the token to a second user, the second user may choose whether or not to accept the token. When the second user receives and accepts the token of the first user, the second user may pass the token on to another user, use the token to request their own token, do nothing with their own token, pass their own token on and/or access the data item 102 linked to the token (whether or not they have used their token). The user may be able to reject the token. Some steps of the method of distributing information may be automated, for example, by use of an app which is downloaded to a user's device, such that the first time a user receives a token, either in response to a request from that user, or because another user has sent them a token in some way, the token is automatically accepted by the user such that the token is used and the user receives their own token.

A user can be prevented from using multiple tokens which refer to the same data item 102. The system can automatically reject a token received by a user if it relates to a data item 102 which relates to a token they have already used. The system can be configured to store information relating to the tokens received by a user, even if not used, to provide an indication of which tokens have been received by a user in relation to which data items. If the system is further configured to automatically reject a token relating to a data item 102 which the user already in some way related to, the user does not receive the information from multiple sources relating to the same data item 102. This reduces the amount of information possibly received by a user such that they do not receive duplicate messages, etc. relating to the same information. This means that the user can avoid receiving possibly large numbers of tokens for the same data item 102.

The system can be configured such that it does not send a token relating to a certain data item 102 to a user if the user has already used a token relating to the same data item 102 from another user or source. Therefore, the user cannot request duplicates of tokens in relation to the same data item 102. A user can choose to reject a token if they knew they would receive the same token from another user at a later date which they would prefer to use.

Users would be likely to know which other users would benefit from the data item 102 linked to the token, which means that users can pass tokens to their friends who they think would be particularly interested. This has multiple benefits. It means that time and money is not wasted on determining which target groups to try to provide tokens for, and it means that it reduces the likelihood that people are bombarded by information which is not particularly relevant to them.

The stored information indicating how the information has passed from one user to another may be accessed in different ways by different people. Users who are signed up to the internet site may be able to see any trees representing the movement of information which has resulted from a token they have passed on. From this it may be possible to determine how the information has passed from user to user. This can be beneficial to all users because if a user can tell that a user to whom they passed tokens always fails to use the token, or pass it on, then it may be a waste of time to pass future tokens on to them. The information a user can see about other users can be limited to address privacy issues.

In a further embodiment of the present invention, the data item 102 is an offer, for example a form of refund available to a user who purchases an item using the offer. In such an embodiment, the source is likely to be a merchant. An on-line app store may be used to provide data items in order to make the data item 102, available to the public and different users. The distribution and tracking of information is as described in any of the above embodiments or variations.

An offer can be any variation or combination of discount or cash back on any number of real or virtual goods or services, or bonus goods or services, as selected by a source. The offer may have terms and conditions in relation to how the offer may be used. The terms and conditions may include limitations on the number of people who may claim the offer, a limitation on when the offer must be used by, a limitation on how many people the offer can be passed on to and/or a limitation of how many times the offer may be used by any one person etc.

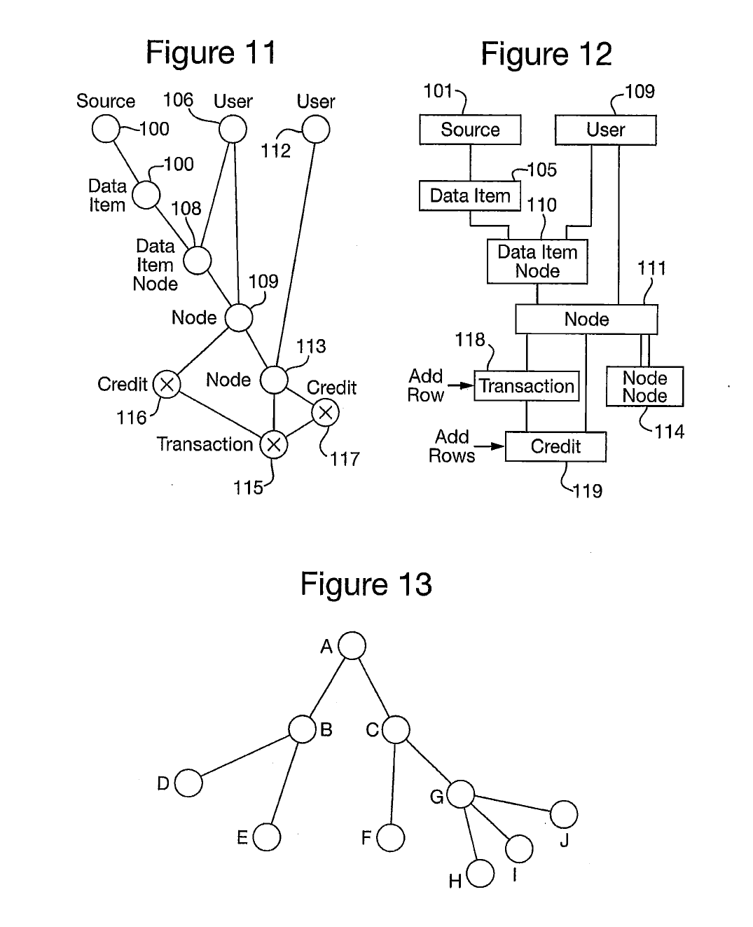

FIG. 11 shows the second user exercising the offer in relation to a token, made available by the first user. Therefore, the second user uses the node 109 made available by the first user. As can be seen, a credit 117 is created which is linked to the node 113, i.e. the credit is linked to the token which has been used to exercise the offer. This can be directly linked to the user who has exercised the offer. The transaction itself can also be seen as another node 115 member in the tree shown in FIG. 11. Therefore, the credit node 117 and the transaction node 115 are both attached to the relevant node 113. A credit node 116 is then created and attached to each node along a pathway to the root node which has been used by a user. In this way, every user in a chain of users from the user who received the token from the source, to a user who has exercised the offer, will receive a credit node. This can be of varying amounts. Desirably the value of the credit node decreases in value from user to user until the root node is reached. If the value of the credit node reaches below a predetermined amount, e.g. the smallest negotiable currency unit, it is desirably set to zero.

The root node relates to the token received by the user from a source. For example, the credit may reduce by half from user to user. The credit received by each user reduces by half if the reward is reducing by 1/n, when n is 2. It may be beneficial to reduce the reward by half as it passes from user to user. If a number is halved, and then the result is halved, and this is repeated multiple times, the sum of the halved values never reaches the full initial value. This means that a proportion of the full value will always be leftover.

As can be seen from FIG. 12, when a node is used for a transaction, the transaction information is stored in a transaction database table 118 and the credit information is stored in a credit database table 119. This information can be used to determine the credit that should then be received by each user. The credit information is related to each individual node, and the transaction. The transaction information is related to the credit on each node.

The present invention has the advantage that the user knows that whoever the offer is passed on to, the next user would receive a reward which is greater than the reward they would make if the offer is exercised by a user further down the chain. Therefore, the user is not as concerned that forwarding offers to other users may be interpreted negatively, because the further user, who has received the offer, will receive a greater benefit than the first user if they exercise the offer.

The user can then exercise the offer in a transaction. The transaction can include a step of transferring money to the source, and in exchange, the user receives goods or services in accordance with the offer and their reward. A transaction record is created for each time an offer is actually exercised. The record includes the unique identifier that was presented for the transaction.

When a transaction occurs, the transaction record is stored in a transaction database table 118 for the identifier code presented for the transaction and a credit is recorded in a credit database table 119. If that identifier code had been passed a token by another identifier code (i.e. it is the ‘child’ of another identifier code) then a credit for that amount, such as half, is attached to the transaction and the parent identifier code. This is repeated, continuing to reduce the values by the pre-determined portion until the ‘root identifier code’ is encountered. Any remainder from the reduced credits, plus the exchange standard transaction costs are recorded in an ‘Exchange Profit’ record which is linked to both the original transaction, and the offer member for the whole ‘ripple’ i.e. for each user in a chain of users.

When a user claims an offer, they will pay the source in exchange for whatever the offer has outlined in accordance with the terms and conditions of the offer. The user can then be refunded for the amount specified in the details of the offer. Alternatively, the user may pay a reduced amount in accordance with the offer, and the reduced amount is received by the source.

If the user decides to exercise the offer, then they receive a full refund in accordance with the offer. The offer itself also passes back the refund to other previous users who led to the user receiving that particular token. The refund received by other users can be decided by the terms and conditions of the offer as provided by the source. For example, the amount refunded may be reduced from user to user. Furthermore, the amount refunded to each user along a chain of users may reduce by half from user to user.

The amount refunded to each user may be a fixed percentage, a pre-specified amount or a varying amount which can be based on a predetermined equation. The amount received by a user may be disproportionately increased if the offer is passed to and/or exercised by over a given number of other users. For example, a user may receive a percentage based reward of X % for referring the offer to the first 20 users and percentage reward of Y % for referring the offer to each user >20, wherein Y>X. This value may be independent of whether or not the referred users exercises the offer. Additionally or alternatively, a user may receive an increased reward if they pass the offer to over a certain number, e.g. 20 users, who exercise the offer. There are various ways in which the user may receive the reward, for example they may receive money, credit, points or a loyalty scheme, crypto currency etc. In both examples, 20 is indicative of a number chosen by the source and can be any positive integer.

In an example, a person is trying to arrange a wedding or party, if a user knows this person is trying to arrange a party or wedding and the person learns of a useful offer, for example a caterer offering a discounted service, the user can specifically pass this offer on to the relevant user. Alternatively, a user may decide to pass this offer on to a large range of users who are likely to be more likely to find the offer beneficial than other users might.

For example, a user may advertise the offer on the radio in the middle of a show about a topic related to the offer or at a certain time when users may be more likely to be interested in the offer. A source or user may arrange to hand out flyers at a related event or make an offer available in any number of ways to target potential users.

Users would know that if they used the token to pass the offer on to another user, the next user would receive a greater refund than they would, which negates the feeling that the user is using the token only for their own economic benefit. Users are less likely to feel uncomfortable using the token to pass an offer, if they know that users who receive the token will receive a greater benefit than they will. Users are unlikely to want to pass on an offer if the future users feel like the previous user is trying to make money out of them. Therefore, by reducing the reward from user to user it means that the next user (and further users downstream in a chain of users) is always going to receive more than the upstream users any particular chain. A user can use the token to send the offer to multiple people, such that the user is involved in multiple downstream chains and in this way, may increase the overall reward they receive from any users which exercise the offer downstream in the chain of that particular user.

A user may exercise the offer relating to a token multiple times. Each time a user exercises the offer, a count node (not shown) may be created in order to count the number of times a user exercises an offer. Each time the user exercises the offer, the count number in a corresponding table increases in value by 1. When the count reaches a predetermined value, e.g. 10, this may trigger an event. The predetermined value may be any positive integer. The event may include the user being offered a reward, an exclusive token and/or a gift. This allows user loyalty to be rewarded. When a user exercises the offer multiple times, a credit node may or may not be created after the first initial credit node, i.e. the previous users in the chain may or may not be rewarded after the user initially exercises the offer.

As can be seen from FIG. 13, when multiple offers are passed on this creates multiple chains of users (A-J) which can be connected in a combination of ways depending on how the information has been passed. For example, a chain of users could form including users A, B and E or A, C, G and I or any other combination of users A-J in which a token may pass from one user to another as shown in FIG. 13. The combination of these chains is likely to produce a more complex combination which is tree-like, as in FIG. 13. The tree can have multiple different branches from any individual user, or the source. The connections between users may already be known. Because of the way the information is passed, each chain can be determined to show how the movement of information develops. Furthermore, it would be possible to determine the movement of information amongst multiple different people, or all the people who have exercised (or not used) an offer in a tree.

The present invention allows monitoring of advertisement, for example if a data item 102 is made available via a radio program, when a user then passes on and/or exercises this offer, it is possible to monitor how the information has passed from user to user as a result of the advertisement. Therefore, the present invention can be used for monitor advertising and marketing. The token passed from user to user can relate to a data item 102 of digital content. In this case, a user might access the data item 102 to download the digital content. This could be used in viral marketing and would allow the movement of this information to be tracked.

It should be noted that although each new piece of information can be an additional row within the same database table, it is possible that the new information can be added in a combination of ways. Instead of information being added in a new row in the same database table each time, information can be added to a new database table eg. there could be multiple database tables all containing offer member information. Or the information can be added and stored in a variety of ways, i.e. some saved to new rows and other pieces of information saved to new tables. This would depend on the most convenient way to store the information in terms of memory space available or how the information might later be interpreted.

In the present invention a source provides a data item 102. Tokens which relate to the data item 102 are made available. The source may make the data item 102 first available in multiple different ways, for example by publishing the data item 102 on an interne site. A first user requests a token from a source. The first user then receives a first token with their individual identifying code and an address in it. A link between the first user and the token is stored. The first user then makes the token available to other users. A second user having received this requests their own token. This may involve going to a specific internet site or shop to request a token for themselves. A link between the second user and the first token is stored. The second user is provided with their own token which includes an address and their own unique identifier. A link between the second token and the second user is stored. The user may choose to use the token. If the token is representative of an offer, the user may use the token by purchasing an item using the offer. In this way, the user will receive a discount in accordance with the offer.

The present invention is described above with reference to specific embodiments. However it should not be construed as limited to those embodiments but only by the appended claims.

1. A method of tracking the distribution of information, the method comprising:
providing to a first user a first token comprising a first unique identifier and a first address;
storing in a first database table a link between the first user and the first token;
receiving at the first address a request from a second user, the request being made using the first token which has been received by the second user from the first user;
storing in a second database table a link between the first token and the second user;
providing to the second user a second token comprising a second unique identifier and a second address in response to the request; and
storing in a third database table a link between the second token and the second user.

2. The method of claim 1 further comprising:
receiving at the second address a request from a third user, the request from the third user being made using the second token which has been received by the third user from the second user;
storing in a fourth database table a link between the second token and the third user;
providing to the third user a third token comprising a third unique identifier and a third address in response to the request from the third user; and
storing in a fifth database table a link between the third token and the third user.

3. The method of claim 1, further comprising:
receiving at the first address a request from a fourth user, the request from the fourth user being made using the first token which has been received by the fourth user from the first user;
storing in a sixth database table a link between the first token and the fourth user;
providing to the fourth user a fourth token comprising a fourth unique identifier and a fourth address in response to the request from the fourth user; and
storing in a seventh database table a link between the fourth token and the fourth user.

4. The method of claim 1, further comprising:
storing a link between a token and a data item in an eighth database table.

5. The method of claim 1, wherein each token further comprises a link to a data item.

6. The method of claim 1, wherein each token generated in response to a request using a previous token, is linked to the same data item as the previous token.

7. The method of claim 1, wherein if a user uses a further token that is linked to a data item to make a request, and the user is already linked to a token that is linked to the same data item, then no further link between the user and the further token is made.

8. The method of claim 1, further comprising:
determining how a user received a token by assembling a chain of users, using the information stored in the database tables.

9. The method of claim 1, wherein the data item is a representation of an offer.

10. The method of claim 1, further comprising providing a record of all the users in a chain of users, through which the user who exercises the offer, has received the token.

11. The method of claim 1, further comprises giving a reward to the user who exercises the others in accordance with the offer.

12. The method of claim 1, further comprising giving a reward to all users in a chain of users through which the user who exercises the offer received the token.

13. The method of claim 1, wherein the reward received by users in the chain reduces from user to user up the chain from the user exercising the offer to the user who receives a token from a source.

14. The method of claim 1, wherein the reward reduces from user to user by a predetermined proportion, optionally wherein this predetermined proportion is 1/n, n being an integer greater than 1.

15. The method of claim 1, wherein the identifier is created when a request is made by a user or wherein the identifier is created prior to a user request.

16. The method of claim 1, where at least two of the addresses are the same.

17. The method of claim 1, wherein at least two of the database tables are the same.

18. A method of distributing information, the method comprising providing a data item;
generating a token linked to the data item and comprising a first unique identifier and a first address, wherein the token is usable in a method according to claim 1; and
making the token available to other persons.

19. A method of distributing information, the method comprising:
receiving at a first address a first token comprising a first unique identifier and a first address;
sending a request including the first unique identifier to the first address;
receiving a second token comprising a second unique identifier and a second address; and
making the second token available to another person.

20. An apparatus for tracking the distribution of information, the apparatus configured to provide a first user a first token comprising a first unique identifier and a first address;
store in a first database table a link between the first user and the first token;
receive at the first address a request from a second user, the request being made using the first token which has been received by the second user from the first user;
store in a second database table a link between the first token and the second user;
provide to the second user a second token comprising a second unique identifier and a second address in response to the request; and
store in a third database table a link between the second token and the second user.

21. A computer program for tracking the distribution of information, the computer program providing to a first user a first token comprising a first unique identifier and a first address;
storing in a first database table a link between the first user and the first token;
receiving at the first address a request from a second user, the request being made using the first token which has been received by the second user from the first user;
storing in a second database table a link between the first token and the second user;
providing to the second user a second token comprising a second unique identifier and a second address in response to the request; and
storing in a third database table a link between the second token and the second user.
